(19) United States
(12) Patent Application Publication
(10) Pub. No.: US 2013/0209339 A1
(43) Pub. Date: Aug. 15, 2013

(54) Methods And Systems For Producing Hydrogen And Capturing Carbon Dioxide

(71) Applicants: Ah-Hyung Alissa Park, New York, NY (US); Kyle J. Fricker, Cocoa Beach, FL (US); Luis Velazquez-Vargas, Cooley, OH (US)

(72) Inventors: Ah-Hyung Alissa Park, New York, NY (US); Kyle J. Fricker, Cocoa Beach, FL (US); Luis Velazquez-Vargas, Cooley, OH (US)

(21) Appl. No.: 13/568,767

(22) Filed: Aug. 7, 2012

Related U.S. Application Data
(60) Provisional application No. 61/680,326, filed on Aug. 7, 2012.
(60) Provisional application No. 61/521,336, filed on Aug. 8, 2011.

(51) Int. Cl. C01B 3/06; B01D 53/62

(52) U.S. Cl. CPC C01B 3/06; B01D 53/62
USPC 423/234; 423/648.1; 422/649

(57) ABSTRACT

Methods and systems for producing hydrogen and capturing carbon dioxide are disclosed. In some embodiments, the methods include the following: mixing magnesium bearing minerals with one or more acids and/or chelating agents to form a magnesium-rich solvent including magnesium hydroxide; mixing a gas including carbon dioxide with the magnesium-rich solvent in a reactor possibly in the presence of one or more water-gas shift catalysts; increasing a temperature and a steam pressure inside the reactor until a substantial portion of the magnesium hydroxide in the solvent and the carbon dioxide and water in the gas react to form magnesium carbonate and hydrogen; and increasing pH in the reactor thereby increasing a rate that the solvent and the carbon dioxide react.

### CROSS REFERENCE TO RELATED APPLICATION(S)

This application claims the benefit of U.S. Provisional Application Nos. 61/521,336 filed Aug. 8, 2011, and 61/680,326, filed Aug. 7, 2012, each of which is incorporated by reference as if disclosed herein in its entirety.

### GOVERNMENT LICENSE RIGHTS

This invention was made with government support under grant/contract no. 5-4565 awarded by the National Science Foundation. The government has certain rights in the invention.

### BACKGROUND

The rapid increase in carbon dioxide emissions from industrial sources has been considered as one of the main causes for the Earth's changing climate. The reduction of carbon dioxide emissions can be achieved by improving energy efficiency, implementing renewable carbon-free energy sources, and developing carbon capture, utilization and storage (CCUS) technologies. Worldwide energy use will continue increasing; and thus, CCUS could provide an immediate solution to the global carbon imbalance while renewable energy technologies develop. By sequestering carbon dioxide, the atmospheric carbon dioxide concentration can be stabilized or reduced. Most focus in the CCUS field has been placed on amine-based carbon dioxide capture combined with geological storage. While these technologies have already been demonstrated in large scales, amine-based carbon dioxide capture process and the geological storage of carbon dioxide still face challenges such as high parasitic energy consumption during solvent regeneration and the permanence and accountability issues for long term carbon dioxide storage. Furthermore, these schemes would not allow direct integration of carbon capture and storage with high temperature energy conversion systems.

A few high temperature carbon capture schemes exist that utilize a metal oxide as carbon capture medium such as Zero Emission Coal Alliance (ZECA) process and calcium looping technologies. Numerous studies have shown that Ca-based sorbents, often in the form of Ca(OH)₂ or CaO derived from CaCO₃, provide substantial carbonation conversion and kinetics. Ca-based sorbents are attractive because they can be prepared using inexpensive resources such as limestone. However, since they are derived from carbonate mineral, Ca-based sorbents cannot be used as direct carbon storage. The spent sorbents need to be regenerated, requiring a significant cost and energy penalty, especially when accounting for sorbent degradation.

A more permanent way of preventing carbon dioxide from entering the atmosphere is a chemical conversion of carbon dioxide to a thermodynamically lower state. Carbon dioxide is the anhydrous form of carbonic acid and, therefore, can be used to displace weaker acids such as silicic acid. The formation of carbonates from silicates, which thermodynamically bind carbon dioxide, is a well known process called mineral weathering. In many instances these carbonates dissolve in water, but some, such as magnesium or calcium carbonates, are remarkably stable as solids. Some of the geologically sequestered carbon dioxide will undergo mineral weathering with surroundings. However, the reaction between mineral and carbon dioxide is very slow in nature, and thus, the portion of carbon storage by mineralization is very limited in the geological sequestration.

The main challenge for carbon mineral sequestration has been the slow dissolution kinetics of minerals. Most of the prior studies on carbon mineral sequestration focused on the pretreatment of the minerals, including heat treatment of serpentine and wet-attrition grinding of Mg-bearing minerals. These methods, however, are highly energy intensive and, since the current energy sources are generally fossil-based, the net amounts of carbon contained by those pretreatment schemes have been found to be significantly less than the amount of carbon dioxide reacted.

### SUMMARY

Embodiments of the disclosed subject matter include methods and systems for both generating hydrogen and capturing carbon dioxide from a gas stream such as combustion gases from solid wastes or flue gas from a carbonaceous-fuel power plant. Magnesium-bearing minerals, e.g. serpentine and olivine, are dissolved to create a solvent including magnesium hydroxide. A combination of acids and/or chelating agents is used to dissolve the magnesium-bearing minerals.

Under high temperature and high steam pressure operating conditions, the gas including carbon dioxide is reacted with the solvent, which captures and stores the carbon dioxide in magnesium carbonate form while producing a stream of hydrogen gas. In some embodiments, additional catalysts are introduced to the reactor to increase the rate of reaction and a high pH swing process is used to increase the amount of carbon dioxide captured.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic diagram of methods and systems according to some embodiments of the disclosed subject matter; and

FIG. 2 is a chart of a method according to some embodiments of the disclosed subject matter.

### DETAILED DESCRIPTION

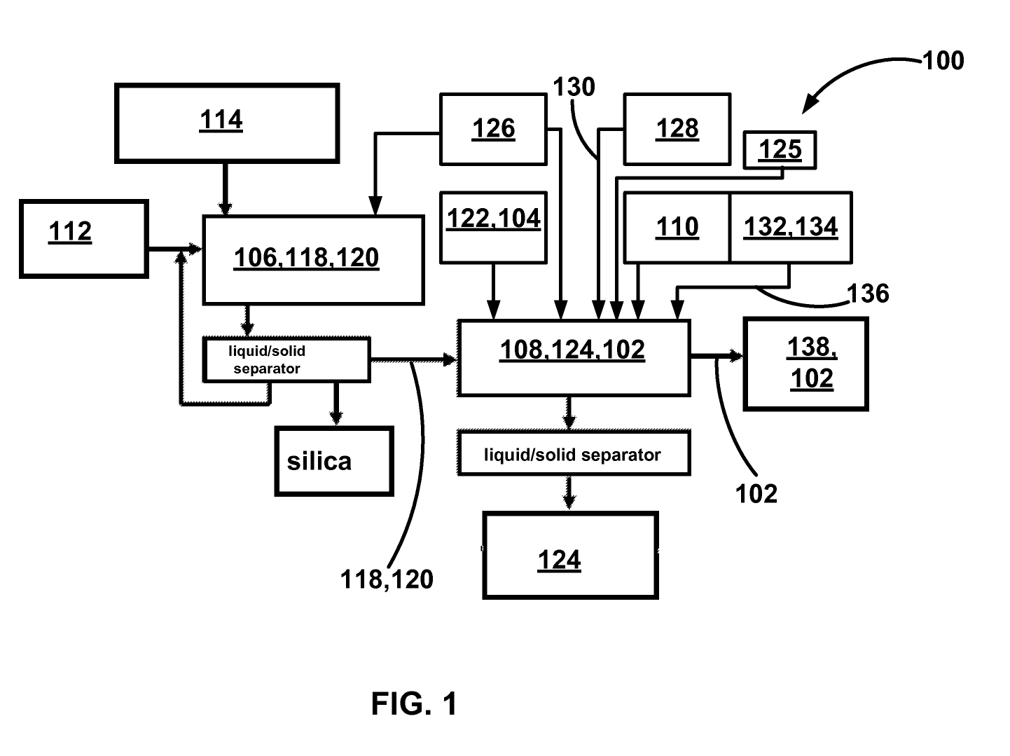

Referring now to FIG. 1, aspects of the disclosed subject matter include a system 100 for producing hydrogen 102 and capturing carbon dioxide 104. In some embodiments, system 100 includes a dissolution reactor 106, a carbonation reactor 108, and a control module 110.

Dissolution reactor 106 is configured for mixing magnesium bearing minerals 112 with at least one of one or more acids and/or chelating agents 114 to form a magnesium-rich solvent 118 including magnesium hydroxide 120.

Carbonation reactor 108 is in fluid communication with dissolution reactor 106. Carbonation reactor 108 is configured for reacting a gas 122 including carbon dioxide 104 with magnesium-rich solvent 118, which is typically injected into the reactor, to form magnesium carbonate 124 and hydrogen 102. In some embodiments, gas 122 is reacted with magnesium-rich solvent 118 in the presence of one or more water-gas shift catalysts 125. Carbonation reactor 108 is configured to withstand an increase in the temperature and the steam pressure inside the reactor until a substantial portion of magnesium hydroxide 120 in solvent 118 and carbon dioxide 104 in gas 122 react to form magnesium carbonate 124 and hydrogen 102.

System 100 typically includes a heat source 126 in fluid communication with dissolution reactor 106 and carbonation reactor 108. Heat source 126 is configured to heat carbonation reactor 108 thereby increasing a temperature inside the reactor.

System 100 includes a steam source 128 in fluid communication with carbonation reactor 108. Steam source 128 is configured to inject steam 130 into carbonation reactor 108 thereby increasing the steam pressure inside the reactor.

In some embodiments, system 100 includes a pH control module 132 in fluid communication with carbonation reactor 108. pH control module 132 includes a supply 134 of basic material 136 for increasing pH in carbonation reactor 108 thereby increasing a rate that solvent 118 and carbon dioxide 104 react.

In some embodiments, system 100 includes a hydrogen collection and storage module 138 or collecting and storing hydrogen 102 produced in carbonation reactor 108.

Control module 110 is used to control system 100 by controlling heat source 126, steam source 128, and pH control module 132. Control module 110 typically, but not always, includes both wired and wireless controls.

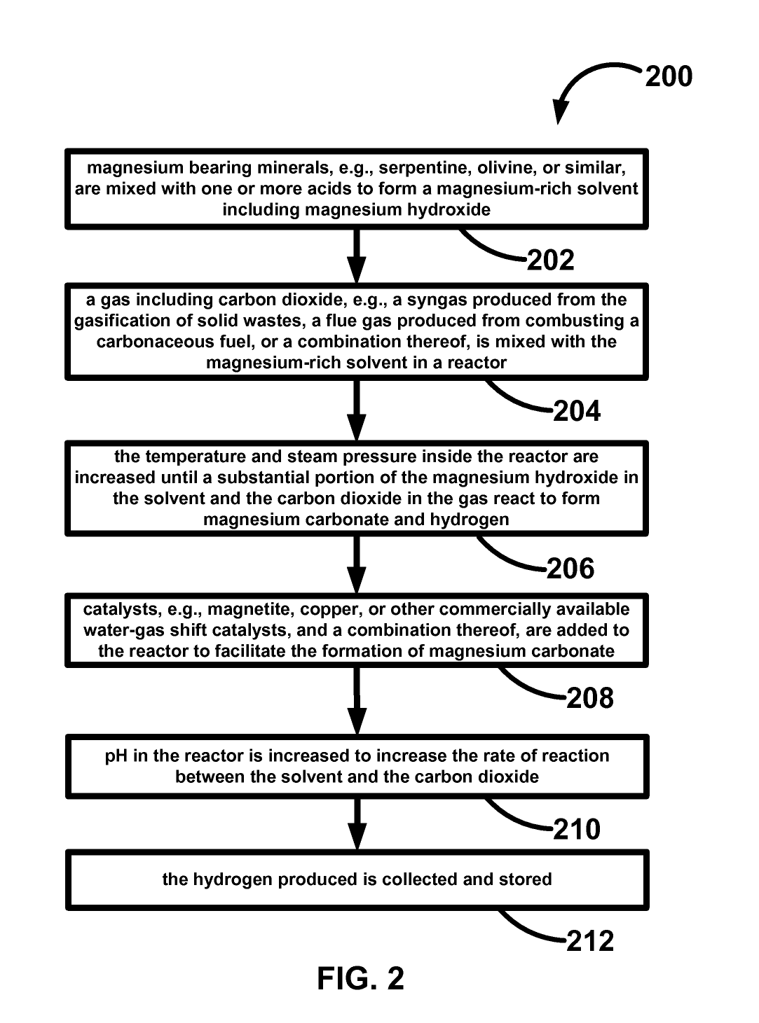

Referring now to FIG. 2, some embodiments of the disclosed subject matter include a method 200 of producing hydrogen and capturing carbon dioxide. At 202, magnesium bearing minerals, e.g., serpentine, olivine, or similar, are mixed with one or more acids and/or chelating agents to form a magnesium-rich solvent including magnesium hydroxide. Examples of the more acids and/or chelating agents include at least one of ethylenediaminetetraacetic acid (EDTA), acetic acid, ascorbic acid, orthophosphoric acid, oxalic acid, chelating agents including catechol, guanidine, imidazole, histidine, and arginine, and a combination thereof.

At 204, a gas including carbon dioxide, e.g., a syngas produced from the gasification of a carbonaceous fuel or solid wastes, a flue gas produced from combusting a carbonaceous fuel or solid wastes, or a combination thereof, is mixed with the magnesium-rich solvent in a reactor.

At 206, the temperature and steam pressure inside the reactor are increased until a substantial portion of the magnesium hydroxide in the solvent and the carbon dioxide in the gas react to form magnesium carbonate and hydrogen. Typically, the temperature in the reactor is limited to about a calcination temperature of magnesium carbonate considering the steam pressure in the reactor. In some embodiments, the temperature is about 200 to about 500 degrees Celsius and the steam pressure in the reactor is about 400 to about 1000 pounds per square inch.

In some embodiments, at 208, catalysts, e.g., magnetite, copper, or other commercially available water-gas shift catalysts, and a combination thereof, are added to the reactor to facilitate the formation of hydrogen. And, in some embodiments, at 210, pH in the reactor is increased to increase the rate of reaction between the solvent and the carbon dioxide.

At 212, the hydrogen produced is collected and stored.

Methods and systems according to the disclosed subject matter offer benefits and advantages over known technologies. Carbon mineralization technology that converts Mg-bearing minerals into mineral carbonates is a CCUS scheme that combines carbon dioxide capture and storage technologies. Research has shown the abundance of suitable minerals, particularly those containing high magnesium fractions, e.g., olivine and serpentine, far exceeds the total carbon dioxide that could be produced from fossil fuel reserves. Mineralized carbon is significantly more thermodynamically stable than gaseous carbon, and carbonation reactions are exothermic. Thus, carbon mineralization is the most secure and permanent solution for carbon storage that does not require long-term monitoring.

Embodiments of the disclosed subject matter are a novel addition to the water-gas shift reaction that provides in situ carbon capture. Technology according to the disclosed subject matter integrates a number of ideas into a method that produces a mineralized carbon capture product with minimal energy demands with no sorbent/solvent regeneration required and a reduced or no need for expensive typical water-gas-shift catalysts. Use of a carbon dioxide reduction technology with such a high efficiency instead of current extreme temperature and pressure reactions reduces industrial carbon footprints. Thus, this technology offers an alternative to expensive carbon capture units and water-gas-shift reactors.

Technology according to the disclosed subject matter improves the efficiency of carbon capture and hydrogen production from refining of hydrocarbon fuels. Technology according to the disclosed subject matter utilizes Mg(OH)₂ as a sorbent, forming a carbon-magnesium mineral. Mg(OH)₂ is easily obtained in non-carbonate mineral form, such as olivine and serpentine. This is a great improvement over calcium-based sorbents such as Ca(OH)₂, which are typically found carbonated and require extensive energy resources to produce and replenish the sorbent. The Mg(OH)₂ is introduced in solution and provides a method for capturing carbon dioxide produced by the water-gas-shift reaction, thus driving the reaction to produce more hydrogen via Le Chatelier's Principle. The resulting carbon-magnesium minerals are thermodynamically stable and can be used as a fire retardant, toothpaste, cosmetics, and many other uses. Technology according to the disclosed subject matter offers an alternative to expensive carbon capture units and catalytic water-gas-shift reactors.

Technology according to the disclosed subject matter offers high efficiency carbon capture without relying on extensive or expensive solvent/sorbent regeneration. It offers benefits to point source emitters, e.g., power plants, cement manufacturers, and refineries, operating in regions and countries utilizing carbon cap-and-trade or a carbon tax. It provides a stable captured form of carbon dioxide for industries that purchase carbon dioxide, e.g., food, beverage, and chemical industries. It produces an alternative fuel source, i.e., hydrogen, for use in fuel cells or internal combustion engines, and useful and stable by-products such as hydromagnesite and nesquehonite.

In some embodiments, a single reactor is used to enhance hydrogen production and capture carbon dioxide. There is no need for energy intensive sorbent/solvent regeneration process. Furthermore, the use of in-situ carbonation process eliminates the need for expensive water-gas-shift catalysts.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A method of producing hydrogen and capturing carbon dioxide, said method comprising:
mixing magnesium bearing minerals with at least one of one or more acids and chelating agents to form a magnesium-rich solvent including magnesium hydroxide;
mixing a gas including carbon dioxide with said magnesium-rich solvent in a reactor; and
increasing a temperature and a steam pressure inside said reactor until a substantial portion of said magnesium hydroxide in said solvent and said carbon dioxide in said gas react to form magnesium carbonate and hydrogen.

2. The method according to claim 1, further comprising:
collecting and storing said hydrogen.

3. The method according to claim 1, further comprising:
adding catalysts to said reactor to facilitate the formation of hydrogen.

4. The method according to claim 3, wherein said catalysts include at least one of magnetite, copper, or other commercially available water-gas shift catalysts, and a combination thereof.

5. The method according to claim 1, wherein said one or more acids and chelating agents include at least one of ethylenediaminetetraacetic acid (EDTA), acetic acid, ascorbic acid, orthophosphoric acid, oxalic acid, chelating agents including catechol, guanidine, imidazole, histidine, and arginine, and a combination thereof.

6. The method according to claim 1, further comprising:
increasing pH in said reactor thereby increasing a rate that said solvent and said carbon dioxide react.

7. The method according to claim 1, wherein said gas is one of a syngas produced from the gasification of a carbonaceous fuel or solid wastes, a flue gas produced from combusting a carbonaceous fuel or solid wastes, and a combination thereof.

8. The method according to claim 1, wherein said temperature in said reactor is limited to about a calcination temperature of magnesium carbonate considering said steam pressure in said reactor.

9. The method according to claim 8, wherein said temperature is about 200 to about 500 degrees Celsius.

10. The method according to claim 8, wherein said steam pressure in said reactor is about 100 to about 1000 pounds per square inch.

11. A system for producing hydrogen and capturing carbon dioxide, said system comprising:
a dissolution reactor for mixing magnesium bearing minerals with at least one of one or more acids and chelating agents to form a magnesium-rich solvent including magnesium hydroxide;
a carbonation reactor in fluid communication with said dissolution reactor, said carbonation reactor being configured for reacting a gas including carbon dioxide with said magnesium-rich solvent to form magnesium carbonate and hydrogen in the presence of one or more catalysts;
a heat source in fluid communication with said dissolution reactor and said carbonation reactor, said heat source being configured to heat said carbonation reactor thereby increasing a temperature inside said reactor;
a steam source in fluid communication with said carbonation reactor, said steam source being configured to inject a steam into said carbonation reactor thereby increasing a steam pressure inside said carbonation reactor; and
a control module for controlling said heat source and said steam source;
wherein said carbonation reactor is configured to withstand an increase in said temperature and said steam pressure inside said reactor until a substantial portion of said magnesium hydroxide in said solvent and said carbon dioxide in said gas react to form magnesium carbonate and hydrogen.

12. The system according to claim 11, wherein said catalysts include at least one of magnetite, copper, or other commercially available water-gas shift catalysts, and a combination thereof.

13. The system according to claim 11, wherein said one or more acids and or chelating agents include at least one of ethylenediaminetetraacetic acid (EDTA), acetic acid, ascorbic acid, orthophosphoric acid, oxalic acid, chelating agents including catechol, guanidine, imidazole, histidine, and arginine, and a combination thereof.

14. The system according to claim 11, further comprising:
a pH control module in fluid communication with said carbonation reactor, said pH control module including a supply of basic material for increasing pH in said carbonation reactor thereby increasing a rate that said solvent and said carbon dioxide react; and
a hydrogen collection and storage module for collecting and storing hydrogen produced in said carbonation reactor.

15. The system according to claim 11, wherein said temperature in said carbonation reactor is limited to about a calcination temperature of magnesium carbonate considering said steam pressure in said reactor.

16. The system according to claim 15, wherein said temperature is about 200 to about 500 degrees Celsius.

17. The system according to claim 15, wherein said steam pressure in said carbonation reactor is about 100 to about 1000 pounds per square inch.

18. A method of producing hydrogen and capturing carbon dioxide, said method comprising:
mixing magnesium bearing minerals with at least one of one or more acids and chelating agents to form a magnesium-rich solvent including magnesium hydroxide;
mixing a gas including carbon dioxide with said magnesium-rich solvent in a reactor in the presence of one or more catalysts;
increasing a temperature and a steam pressure inside said reactor until a substantial portion of said magnesium hydroxide in said solvent and said carbon dioxide in said gas react to form magnesium carbonate and hydrogen; and
increasing pH in said reactor thereby increasing a rate that said solvent and said carbon dioxide react.

19. The method according to claim 18, wherein said catalysts include at least one of magnetite, copper, or other commercially available water-gas shift catalysts, and a combination thereof.

20. The method according to claim 18, wherein said one or more acids and or chelating agents include at least one of ethylenediaminetetraacetic acid (EDTA), acetic acid, ascorbic acid, orthophosphoric acid, oxalic acid, chelating agents including catechol, guanidine, imidazole, histidine, and arginine, and a combination thereof.
